(19) United States
(12) Patent Application Publication
(10) Pub. No.: US 2026/0149216 A1
(43) Pub. Date: May 28, 2026

(54) CHARGING DOCK HOUSING, CHARGING DOCK MODULE AND CHARGING DOCK

(71) Applicants: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(72) Inventors: Renyi (Ronny) Dou, Suzhou (CN); Fangyue (Jason) Zhu, Shanghai (CN); Tiancheng Cao, Suzhou (CN); Jinshun (Jet) Wang, Suzhou (CN)

(73) Assignees: Tyco Electronics (Suzhou) Ltd., Suzhou City (CN); Tyco Electronics (Shanghai) Co., Ltd., Shanghai (CN); Tyco Electronics Technology (SIP) Co., Ltd., Suzhou (CN)

(21) Appl. No.: 19/401,548

(22) Filed: Nov. 26, 2025

(30) Foreign Application Priority Data
Nov. 26, 2024 (CN) 202411710396.9

(51) Int. Cl. H01R 13/428; H01R 13/02; H01R 13/447; H01R 13/50; H01R 13/52; H01R 13/66; H01R 13/73

(52) U.S. Cl. CPC H01R 13/428; H01R 13/025; H01R 13/447; H01R 13/50; H01R 13/521; H01R 13/6683; H01R 13/73; H01R 2201/26

(57) ABSTRACT

A charging dock housing includes a first insertion hole receiving a power terminal, a second insertion hole receiving a signal terminal, and a buckle feature. The charging dock housing is a one-piece molded part and is insertable into an inner cavity of a mounting seat of a charging dock. The buckle feature engages with a mating buckle feature on the mounting seat to lock the charging dock housing into the mounting seat.

### CROSS-REFERENCE TO RELATED APPLICATION

This application claims the benefit of the filing date under 35 U.S.C. § 119(a)-(d) of Chinese Application No. 202411710396.9, filed on Nov. 26, 2024.

### FIELD OF THE INVENTION

The present invention relates to a charging dock housing, a charging dock module comprising the charging dock housing, and a charging dock comprising the charging dock module.

### BACKGROUND OF THE INVENTION

A charging dock typically includes a housing, a mounting bracket, a power terminal, a signal terminal, a lead frame, and a temperature sensor. The mounting bracket is used to fix to an installation panel, for example, to the vehicle body sheet metal. The housing usually consists of a front housing and a rear housing assembled together. The front housing is fixed to the mounting bracket by screws. A first insertion hole for inserting the power terminal and a second insertion hole for inserting the signal terminal are formed in the front housing. The temperature sensor is integrated on the lead frame, which is installed in the rear housing. The temperature sensor is in thermal contact with the power terminal to detect the temperature of the power terminal. The signal terminal is electrically connected to the lead frame. The existing charging dock has the drawbacks of complex structure, an excessive number of components, and high cost.

### SUMMARY OF THE INVENTION

A charging dock housing includes a first insertion hole receiving a power terminal, a second insertion hole receiving a signal terminal, and a buckle feature. The charging dock housing is a one-piece molded part and is insertable into an inner cavity of a mounting seat of a charging dock. The buckle feature engages with a mating buckle feature on the mounting seat to lock the charging dock housing into the mounting seat.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a charging dock according to an exemplary embodiment of the present invention;

FIG. 2 shows an illustrative exploded view of a charging dock according to an exemplary embodiment of the present invention;

FIG. 3 shows an exploded sectional view of a charging dock according to an exemplary embodiment of the present invention;

FIG. 4 shows a plan sectional view of a charging dock according to an exemplary embodiment of the present invention;

FIG. 5 shows an illustrative perspective view of a charging dock housing according to an exemplary embodiment of the present invention;

FIG. 6 shows an illustrative exploded view of a charging dock module according to an exemplary embodiment of the present invention;

FIG. 7 shows an exploded sectional view of a charging dock module according to an exemplary embodiment of the present invention;

FIG. 8 shows a plan sectional view of a charging dock module according to an exemplary embodiment of the present invention;

FIG. 9 shows another illustrative exploded view of a charging dock module according to an exemplary embodiment of the present invention; and

FIG. 10 shows another plan sectional view of a charging dock module according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

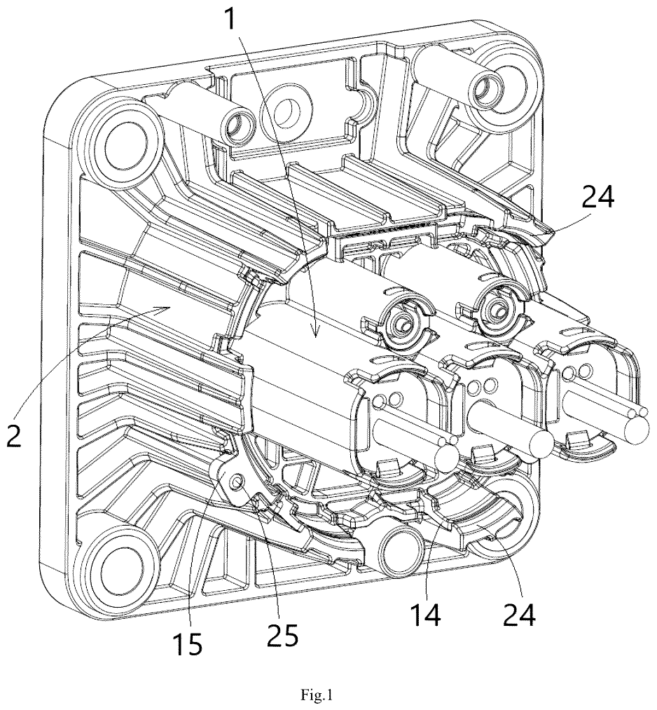

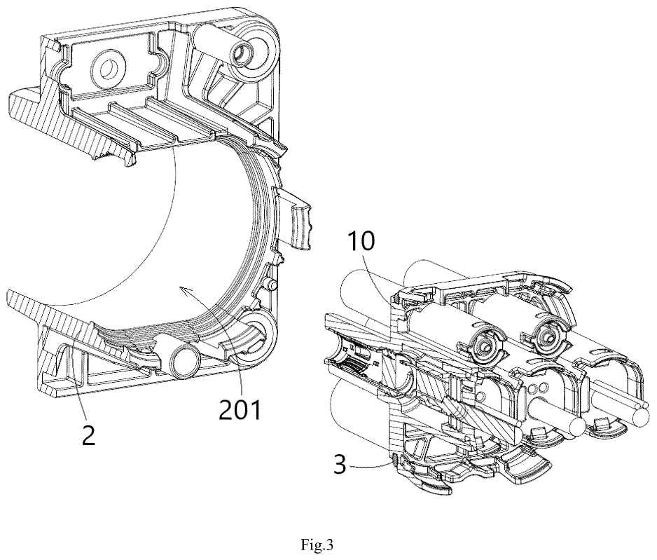

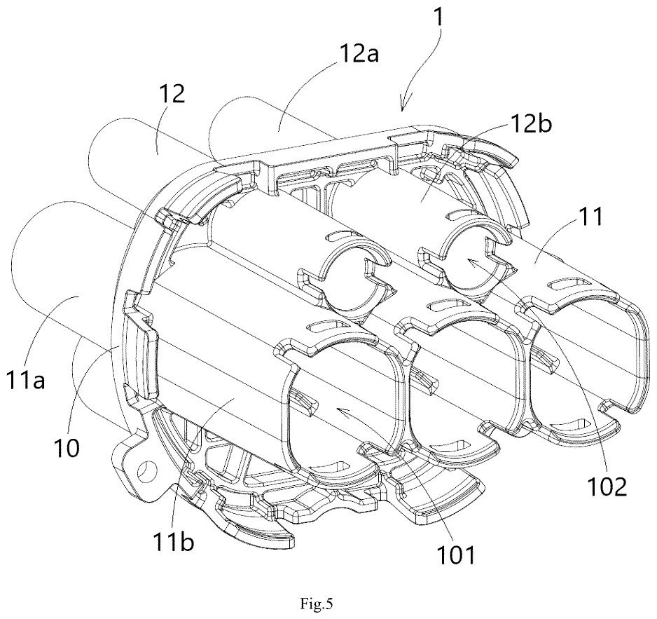

As shown in FIGS. 1 to 10, in an exemplary embodiment of the present invention, a charging dock housing 1 is disclosed. A first insertion hole 101 for inserting a power terminal 4 and a second insertion hole 102 for inserting a signal terminal 5 are formed in the charging dock housing 1, as shown in FIG. 5. The charging dock housing 1 is a one-piece molded part and is suitable for being inserted into an inner cavity 201 of a mounting seat 2 of a charging dock. A buckle feature is formed on the charging dock housing 1, which is suitable for engaging with a mating buckle feature on the mounting seat 2 to lock the charging dock housing 1 into the mounting seat 2. In the illustrated embodiment, the charging dock housing 1 can be an integral injection molded part.

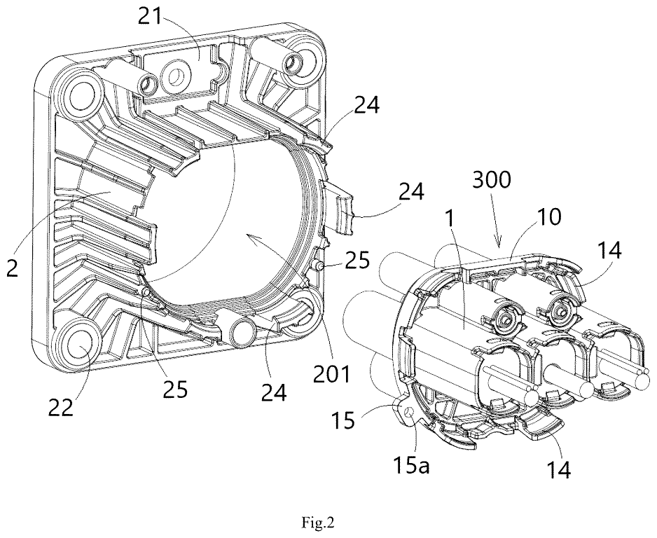

As shown in FIGS. 2 to 5, in the illustrated embodiment, the charging dock housing 1 includes a cover plate 10, which is used to cover the rear port of the inner cavity 201 of the mounting seat 2. The aforementioned buckle feature includes multiple first claws 14 formed on the rear side of the peripheral portion of the cover plate 10, which are distributed at intervals in the circumferential direction of the cover plate 10 and used to respectively engage with multiple second claws 24 on the mounting seat 2.

In the illustrated embodiment, a positioning feature is also formed on the cover plate 10 of the charging dock housing 1, which is suitable for engaging with a mating positioning feature on the mounting seat 2 to position the charging dock housing 1 in the circumferential direction. The aforementioned positioning feature includes multiple positioning ears 15, shown in FIGS. 1 and 2 formed on the rear side of the peripheral portion of the cover plate 10. The multiple positioning ears 15 are distributed at intervals in the circumferential direction of the cover plate 10, and positioning holes 15a are formed in the positioning ears 15, which are suitable for engaging with the positioning posts 25 on the mounting seat 2.

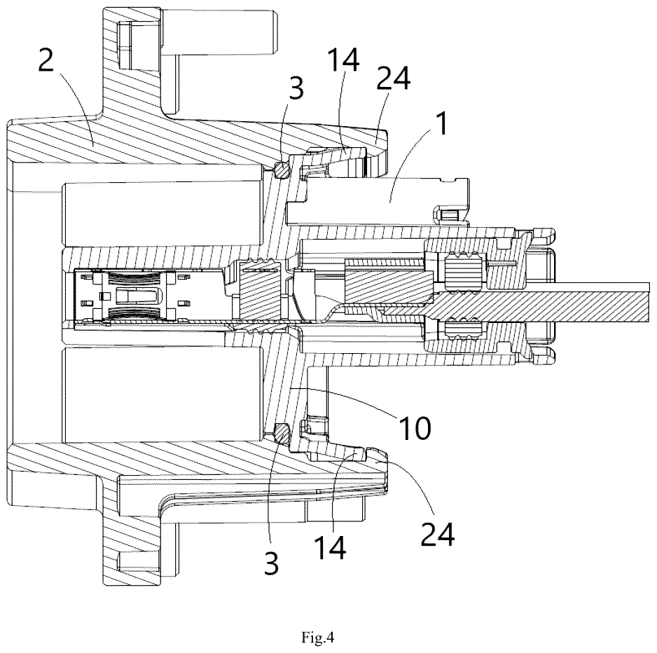

In the illustrated embodiment, a sealing ring installation groove is formed on the circumferential surface of the cover plate 10 for installing a sealing ring 3, so as to achieve sealing between the cover plate 10 and the mounting seat 2 through the sealing ring 3 installed in the sealing ring installation groove, as shown in FIG. 4.

As shown in FIG. 5, in the illustrated embodiment, the charging dock housing 1 further comprises a first cylindrical portion 11 and a second cylindrical portion 12. The first cylindrical portion 11 is connected to the cover plate 10 and has a first front cylindrical portion 11a and a first rear cylindrical portion 11b located on the front and rear sides of the cover plate 10, respectively. The second cylindrical portion 12 is connected to the cover plate 10 and has a second front cylindrical portion 12a and a second rear cylindrical portion 12b located on the front and rear sides of the cover plate 10, respectively. The first insertion hole 101 and the second insertion hole 102 are formed in the first cylindrical portion 11 and the second cylindrical portion 12, respectively. The first front cylindrical portion 11a and the second front cylindrical portion 12a are suitable for insertion into the inner cavity 201 of the mounting seat 2, for mating with a charging gun inserted into the inner cavity 201 of the mounting seat 2.

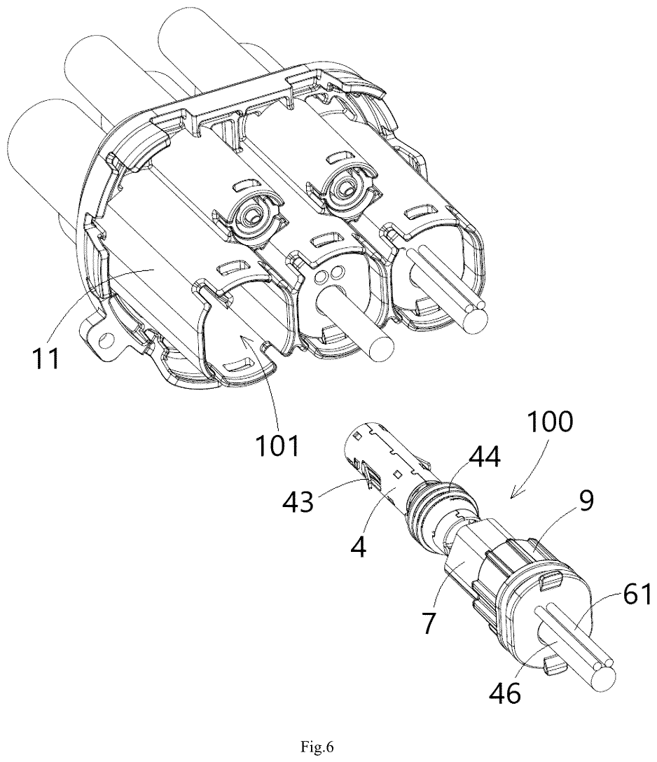

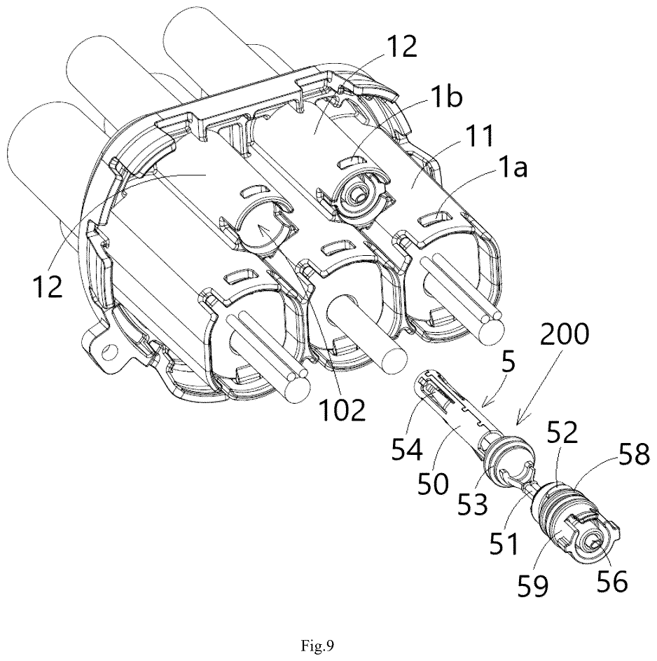

As shown in FIG. 2, in another exemplary embodiment of the present invention, a charging dock module 300 is also disclosed. The charging dock module 300 includes a charging dock housing 1, a first electrical connection assembly 100, shown in FIG. 6, and a second electrical connection assembly 200, shown in FIG. 9. The charging dock housing 1 is suitable for being inserted into the inner cavity 201 of the mounting seat 2 of the charging dock. The first electrical connection assembly 100 includes a power terminal 4 and is inserted into the first insertion hole 101 of the charging dock housing 1. The second electrical connection assembly 200 includes a signal terminal 5 and is inserted into the second insertion hole 102 of the charging dock housing 1.

As shown in FIGS. 5 to 7, in the illustrated embodiment, the first electrical connection assembly 100 further includes a temperature sensor 6, which is set in the first insertion hole 101 for detecting the temperature of the power terminal 4. The leads 61 of temperature sensor 6 are led out from the rear port of the first insertion hole 101. In the illustrated embodiment, the first electrical connection assembly 100 further includes a first cable (also known as a high-voltage cable) 46, which is connected to the rear end of the power terminal 4 and led out from the rear port of the first insertion hole 101.

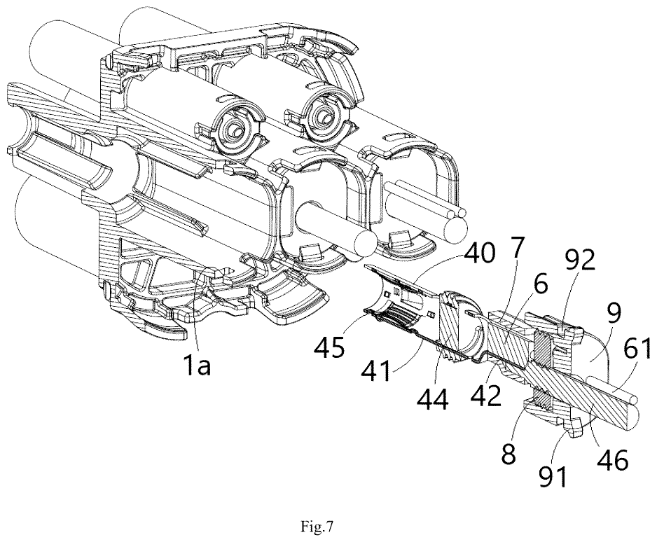

As shown in FIG. 7, in the illustrated embodiment, the power terminal 4 includes a terminal body 40, which has a cylindrical portion 41 and a welding portion 42 connected to the rear end of the cylindrical portion 41. The front end of the first cable 46 is welded to the welding portion 42. In the illustrated embodiment, the first electrical connection assembly 100 further includes a heat shrink tube 7, which is fitted and heat shrunk on the welding portion 42 of the power terminal 4, the front end of the first cable 46, and the main body 60 of the temperature sensor 6. The welding portion 42 of the power terminal 4 is flat and has two opposite sides in its thickness direction. The main body 60 of the temperature sensor 6 is in thermal contact with one side of the welding portion 42, and the front end of the first cable 46 is welded to the other side of the welding portion 42.

As shown in FIG. 6, in the illustrated embodiment, the first electrical connection assembly 100 further includes a first end cap 9, which is installed and fixed to the rear port of the first insertion hole 101. The first end cap 9 has through-holes that allow the first cable 46 and the leads 61 of the temperature sensor 6 to pass through, respectively.

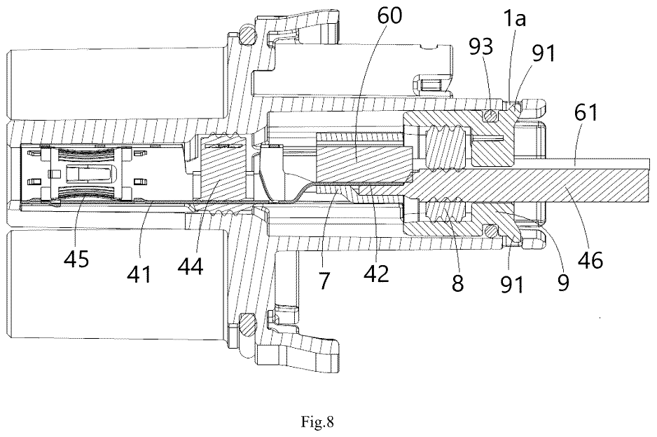

As shown in FIG. 7 in the illustrated embodiment, the first end cap 9 has multiple first elastic buckles 91, and multiple first snap slots 1a are formed on the peripheral wall of the rear port of the first insertion hole 101. The multiple first elastic buckles 91 are respectively engaged with the multiple first snap slots 1a to fix the first end cap 9 to the rear port of the first insertion hole 101. In the illustrated embodiment, the first electrical connection assembly 100 further includes a first sealing plug 8, which is provided in the first end cover 9 and formed with through-holes allowing the first cable 46 and the leads 61 of the temperature sensor 6 to pass through, respectively. The first sealing plug 8 is used to achieve sealing between the first cable 46 and the first end cap 9, as well as between the lead 61 and the first end cap 9, as shown in FIG. 8.

As shown in FIG. 7, in the illustrated embodiment, a circle of mounting groove 92 is formed on the outer side of the first end cover 9. The first electrical connection assembly 100 also includes a sealing ring 93, shown in FIG. 8, which is installed in the installation groove 92 of the first end cover 9. The sealing ring 93 is radially compressed between the inner peripheral surface of the first end cover 9 and the rear port of the first insertion hole 101 to achieve sealing between the two.

As shown in FIG. 7, in the illustrated embodiment, the power terminal 4 further includes an elastic contact component 45, which is inserted into the front of the cylindrical portion 41 of the terminal body 40 to make electrical contact with a mating power terminal of the inserted charging gun. The terminal body 40 and the elastic contact component 45 are integral stamped parts, respectively.

As shown in FIG. 7, in the illustrated embodiment, the power terminal 4 further comprises a first sealing component 44, which is injection molded onto the cylindrical portion 41 of the terminal body 40 and enters the inner cavity of the cylindrical portion 41 through an opening on the cylindrical portion 41. The first sealing component 44 is used to seal the inner cavity of the cylindrical portion 41 of the terminal body 40 and the first insertion hole 101 of the charging dock housing 1.

As shown in FIG. 6, in the illustrated embodiment, a first locking spring 43 is formed on the cylindrical portion 41 of the terminal body 40, and the first locking spring 43 is engaged with the inner wall of the first insertion hole 101 to lock the power terminal 4 in the first insertion hole 101.

As shown in FIG. 9, in the illustrated embodiment, the second electrical connection assembly 200 further includes a second cable (also known as a low-voltage cable) 56, which is connected to the rear end of the signal terminal 5 and led out from the rear port of the second insertion hole 102. In the illustrated embodiment, the signal terminal 5 has a cylindrical body 50 and a cable crimping portion 51 connected to the rear end of the cylindrical body 50. The cable crimping portion 51 is crimped to the front end of the second cable 56 to be electrically connected to the second cable 56.

As shown in FIG. 9, in the illustrated embodiment, the second electrical connection assembly 200 further includes a second sealing plug 58, which is disposed in the rear port of the second insertion hole 102 and formed with a through-hole allowing the second cable 56 to pass through. The second sealing plug 58 is used to achieve sealing between the second cable 56 and the inner peripheral surface of the second insertion hole 102.

As shown in FIG. 9, in the illustrated embodiment, the signal terminal 5 also has a sealing plug crimping portion 52 connected to the rear end of the cable crimping portion 51. The sealing plug crimping portion 52 is crimped onto the front end of the second sealing plug 58 to fix the second sealing plug 58 to the signal terminal 5.

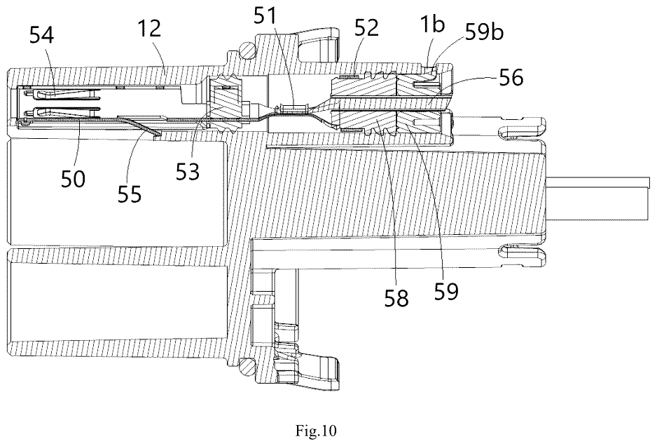

As shown in FIG. 9, in the illustrated embodiment, the second electrical connection assembly 200 further includes a second end cap 59, which is installed and fixed to the rear port of the second insertion hole 102 and formed with a through-hole allowing the second cable 56 to pass through. The second end cap 59 is pressed against the rear end of the second sealing plug 58, used to hold the second sealing plug 58 in the rear port of the second insertion hole 102. In the illustrated embodiment, as shown in FIG. 10, the second end cap 59 has multiple second elastic buckles 59b, and multiple second snap slots 1b are formed on the peripheral wall of the rear port of the second insertion hole 102. The multiple second elastic buckles 59b are respectively engaged with the multiple second snap slots 1b to fix the second end cap 59 to the rear port of the second insertion hole 102.

As shown in FIG. 10, in the illustrated embodiment, a second locking spring 55 is formed on the cylindrical body 50 of the signal terminal 5, and the second locking spring 55 is engaged with the inner wall of the second insertion hole 102 to lock the signal terminal 5 in the second insertion hole 102. In the illustrated embodiment, multiple contact spring pieces 54 are formed on the front part of the cylindrical body 50 of the signal terminal 5, and the multiple contact spring pieces 54 are distributed at intervals in the circumferential direction of the signal terminal 5 for electrical contact with the inserted mating signal terminal.

As shown in FIG. 10, in the illustrated embodiment, the signal terminal 5 further includes a second sealing component 53, which is injection molded onto the cylindrical body 50 of the signal terminal 5 and enters the inner cavity of the cylindrical body 50 through an opening on the cylindrical body 50. The second sealing component 53 is used to seal the inner cavity of the cylindrical body 50 of the signal terminal 5 and the second insertion hole 102 of the charging dock housing 1.

As shown in FIG. 4, in the illustrated embodiment, the charging dock module 300 further comprises a sealing ring 3, which is fitted onto the charging dock housing 1 and adapted to be compressed between the charging dock housing 1 and the mounting seat 2 to achieve sealing between the two.

In another exemplary embodiment of the present invention, a charging dock is also disclosed. The charging dock includes: a mounting seat 2 and a charging dock module 300. The mounting seat 2 is used to fix to an installation panel (such as vehicle body sheet metal) and formed with an inner cavity 201. The charging dock module 300 is inserted into the inner cavity 201 of the mounting seat 2.

In the illustrated embodiment, a mating buckle feature is formed on the mounting seat 2, which engages with the buckle feature on the charging dock housing 1 to lock the charging dock housing 1 into the mounting seat 2. As shown in FIGS. 1, 2, and 4, in the illustrated embodiment, the mating buckle feature includes multiple second claws 24 formed on the rear end of the mounting seat 2, which are distributed at intervals in the circumferential direction of the mounting seat 2. The multiple second claws 24 are respectively engaged with multiple first claws 14 on the cover plate 10 of the charging dock housing 1.

Please note that the buckle features and mating buckle features in the present invention are not limited to the illustrated embodiments, and other buckle structures can also be used, such as elastic buckles with slots and protrusions suitable for engagement with slots.

As shown in FIGS. 1 to 10, in the illustrated embodiment, a mating positioning feature is formed on the mounting seat 2, which is engaged with the positioning feature on the charging dock housing 1 to position the charging dock housing 1 in the circumferential direction.

As shown in FIGS. 1 and 2, in the illustrated embodiment, the mating positioning feature includes multiple positioning posts 25 formed on the rear end face of the mounting seat 2, which are distributed at intervals in the circumferential direction of the mounting seat 2. The multiple positioning posts 25 are respectively engaged with the positioning holes 15a in the multiple positioning ears 15 on the charging dock housing 1.

As shown in FIG. 2, in the illustrated embodiment, the mounting seat 2 has a flange portion 21, and a connection hole 22 is formed in the flange portion 21 to allow a threaded connection member to pass through, so that the flange portion 21 can be fastened to the installation panel through the threaded connection member passing through the connection hole 22.

Please note that the positioning features and mating positioning features in the present invention are not limited to the illustrated embodiments, and other positioning structures can also be used, such as positioning slots and positioning protrusions suitable for engagement with the positioning slots.

In the aforementioned exemplary embodiments according to the present invention, the charging dock housing is a one-piece molded part and is fastened to the mounting seat. Therefore, the present invention simplifies the structure of the charging dock, reduces the number of components of the charging dock, and lowers the cost.

In addition, in the aforementioned exemplary embodiments of the present invention, the temperature signal of the temperature sensor is led out from the charging dock housing through a lead, and the signal of the signal terminal is led out from the charging dock housing through a cable. Therefore, the present invention eliminates the lead frame in the prior art and further simplifies the structure of the charging dock.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A charging dock housing, comprising:
a first insertion hole receiving a power terminal;
a second insertion hole receiving a signal terminal; and
a buckle feature, the charging dock housing is a one-piece molded part and is insertable into an inner cavity of a mounting seat of a charging dock, the buckle feature engages with a mating buckle feature on the mounting seat to lock the charging dock housing into the mounting seat.

2. The charging dock housing according to claim 1, further comprising a cover plate covering a rear port of the inner cavity of the mounting seat, the buckle feature includes a plurality of first claws formed on a rear side of a peripheral portion of the cover plate, the first claws are distributed at intervals in a circumferential direction of the cover plate and respectively engage a plurality of second claws on the mounting seat.

3. The charging dock housing according to claim 2, wherein the cover plate has a positioning feature engaging a mating positioning feature on the mounting seat to position the charging dock housing in the circumferential direction.

4. The charging dock housing according to claim 2, further comprising:
a first cylindrical portion connected to the cover plate and having a first front cylindrical portion and a first rear cylindrical portion located on a front side and a rear side of the cover plate, respectively; and
a second cylindrical portion connected to the cover plate and having a second front cylindrical portion and a second rear cylindrical portion located on a front side and a rear side of the cover plate, respectively, the first insertion hole and the second insertion hole are respectively formed in the first cylindrical portion and the second cylindrical portion, the first front cylindrical portion and the second front cylindrical portion are insertable into the inner cavity of the mounting seat to mate with a charging gun inserted into the inner cavity of the mounting seat.

5. A charging dock module, comprising:
a charging dock housing that is a one-piece molded part insertable into an inner cavity of a mounting seat of a charging dock, the charging dock housing including a first insertion hole receiving a power terminal, a second insertion hole receiving a signal terminal, and a buckle feature engaging with a mating buckle feature on the mounting seat to lock the charging dock housing into the mounting seat;
a first electrical connection assembly which includes a power terminal and is inserted into the first insertion hole of the charging dock housing; and
a second electrical connection assembly which includes a signal terminal and is inserted into the second insertion hole of the charging dock housing.

6. The charging dock module according to claim 5, wherein the first electrical connection assembly includes a temperature sensor disposed in the first insertion hole and detecting a temperature of the power terminal, a plurality of leads of the temperature sensor are led out from a rear port of the first insertion hole.

7. The charging dock module according to claim 6, wherein the first electrical connection assembly includes:
a first cable connected to a rear end of the power terminal and led out from the rear port of the first insertion hole; and
a first end cap installed and fixed into the rear port of the first insertion hole, the first end cap has a plurality of through-holes that allow the first cable and the leads of the temperature sensor to pass through.

8. The charging dock module according to claim 7, wherein the first end cap has a plurality of first elastic buckles, and a plurality of first snap slots are formed on a peripheral wall of the rear port of the first insertion hole, the first elastic buckles are respectively engaged with the first snap slots to fix the first end cap to the rear port of the first insertion hole.

9. The charging dock module according to claim 8, the first electrical connection assembly includes a first sealing plug disposed in the first end cap and having a plurality of through-holes allowing the first cable and the leads of the temperature sensor to pass through, the first sealing plug seals between the first cable and the first end cap, and between the leads and the first end cap.

10. The charging dock module according to claim 6, wherein the power terminal includes a terminal body having a cylindrical portion and a welding portion connected to a rear end of the cylindrical portion, and further includes at least one of:
an elastic contact component inserted into a front part of the cylindrical portion of the terminal body and electrically contacting an inserted mating power terminal, the terminal body and the elastic contact component are respectively integral stamped parts;
a first sealing component injection molded onto the cylindrical portion of the terminal body and entering an inner cavity of the cylindrical portion through an opening on the cylindrical portion, the first sealing component seals the inner cavity of the cylindrical portion of the terminal body and the first insertion hole of the charging dock housing; and
a first locking spring formed on the cylindrical portion of the terminal body, the first locking spring engages an inner wall of the first insertion hole to lock the power terminal in the first insertion hole.

11. The charging dock module according to claim 5, wherein the second electrical connection assembly includes a second cable connected to a rear end of the signal terminal and led out from a rear port of the second insertion hole, the signal terminal has a cylindrical body and a cable crimping portion connected to a rear end of the cylindrical body, the cable crimping portion is crimped to a front end of a second cable electrically connected to the second cable.

12. The charging dock module according to claim 11, wherein the second electrical connection assembly includes a second sealing plug disposed in the rear port of the second insertion hole and having a through-hole allowing the second cable to pass through, the second sealing plug seals between the second cable and an inner circumferential surface of the second insertion hole.

13. The charging dock module according to claim 12, wherein the signal terminal has a sealing plug crimping portion connected to a rear end of the cable crimping portion, the sealing plug crimping portion is crimped onto a front end of the second sealing plug to fix the second sealing plug to the signal terminal.

14. The charging dock module according to claim 12, wherein the second electrical connection assembly includes a second end cap installed and fixed into the rear port of the second insertion hole and having a through-hole allowing the second cable to pass through, the second end cap is pressed against a rear end of the second sealing plug and holds the second sealing plug in the rear port of the second insertion hole.

15. The charging dock module according to claim 14, wherein the second end cap has a plurality of second elastic buckles, and a plurality of second snap slots are formed on a peripheral wall of the rear port of the second insertion hole, the second elastic buckles are respectively engaged with the second snap slots to fix the second end cap to the rear port of the second insertion hole.

16. The charging dock module according to claim 11, wherein a second locking spring is formed on the cylindrical body of the signal terminal, the second locking spring engages with an inner wall of the second insertion hole to lock the signal terminal in the second insertion hole.

17. The charging dock module according to claim 11, wherein a plurality of contact spring pieces are formed on a front part of the cylindrical body of the signal terminal, the contact spring pieces are distributed at intervals in a circumferential direction of the signal terminal to electrically contact an inserted mating signal terminal.

18. The charging dock module according to claim 11, wherein the signal terminal includes a second sealing component injection molded onto the cylindrical body of the signal terminal and entering an inner cavity of the cylindrical body through an opening on the cylindrical body, the second sealing component seals the inner cavity of the cylindrical body of the signal terminal and the second insertion hole of the charging dock housing.

19. The charging dock module according to claim 5, further comprising a sealing ring fitted onto the charging dock housing and compressed between the charging dock housing and the mounting seat to achieve sealing between the charging dock housing and the mounting seat.

20. A charging dock, comprising:
a mounting seat fixed to an installation panel and having an inner cavity; and
a charging dock module inserted into the inner cavity of the mounting seat, the charging dock module including:
a charging dock housing that is a one-piece molded part, the charging dock housing including a first insertion hole receiving a power terminal, a second insertion hole receiving a signal terminal, and a buckle feature engaging with a mating buckle feature on the mounting seat to lock the charging dock housing into the mounting seat;
a first electrical connection assembly which includes a power terminal and is inserted into the first insertion hole of the charging dock housing; and
a second electrical connection assembly which includes a signal terminal and is inserted into the second insertion hole of the charging dock housing.
